(19) United States
(12) Patent Application Publication
(10) Pub. No.: US 2018/0332298 A1
(43) Pub. Date: Nov. 15, 2018

(54) Bidirectional Prediction In Video Compression

(71) Applicant: Futurewei Technologies, Inc., Plano, TX (US)

(72) Inventors: Shan Liu, San Jose, CA (US); Jiali Fu, Shenzhen (CN); Shan Gao, Shenzhen (CN)

(21) Appl. No.: 15/947,219

(22) Filed: Apr. 6, 2018

Related U.S. Application Data
(60) Provisional application No. 62/504,466, filed on May 10, 2017.

(51) Int. Cl. H04N 19/51; H04N 19/463; H04N 19/96; H04N 19/184; H04N 19/176

(52) U.S. Cl. CPC H04N 19/51; H04N 19/463; H04N 19/176; H04N 19/184; H04N 19/96

(57) ABSTRACT

A method of coding is provided. The method may be implemented by an encoder. The method includes dividing available weights for a current inter block into weight subsets, selecting one of the weight subsets, encoding a weight subset flag into a particular portion of a bitstream, wherein the weight subset flag contains a weight subset index used to identify the one of the weight subsets that was selected, and transmitting the bitstream containing the weight subset flag to a decoding device.

### CROSS-REFERENCE TO RELATED APPLICATIONS

This patent application claims the benefit of U.S. Provisional Patent Application No. 62/504,466, filed May 10, 2017, by Shan Liu, et al., and titled “Method and Apparatus for Bidirectional Prediction in Video Compression,” the teaching and disclosure of which is hereby incorporated in its entirety by reference thereto.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video images. The compressed data is then received at the destination by a video decompression device that decodes the video data. With limited network resources and ever increasing demands of higher video quality, improved compression and decompression techniques that improve compression ratio with little to no sacrifice in image quality are desirable.

### SUMMARY

According to one aspect of the present disclosure, there is provided a method of coding implemented by a decoder. The method includes receiving a bitstream containing a weight subset flag in a particular portion; identifying a weight subset using the weight subset flag, wherein the weight subset comprises a subset of available weights for a current inter block; and displaying, on a display of an electronic device, an image generated using the weight subset that was identified by the weight subset flag.

Optionally, in any of the preceding aspects, another implementation of the aspect provides that the available weights correspond to generalized bi-prediction (GBi).

Optionally, in any of the preceding aspects, another implementation of the aspect provides that the particular portion is a sequence parameter set (SPS) level of the bitstream.

Optionally, in any of the preceding aspects, another implementation of the aspect provides that the particular portion is a picture parameter set (PPS) level of the bitstream.

Optionally, in any of the preceding aspects, another implementation of the aspect provides that the particular portion is a slice header of the bitstream.

Optionally, in any of the preceding aspects, another implementation of the aspect provides that the particular portion is a region of the bitstream represented by a coding tree unit (CTU) or group of CTUs.

Optionally, in any of the preceding aspects, another implementation of the aspect provides that the available weights for the current block include at least one weight in addition to −¼, ¼, ⅜, ½, ⅝, ¾, and 5/4.

According to one aspect of the present disclosure, there is provided a method of coding implemented by an encoder. The method includes dividing available weights for a current inter block into weight subsets; selecting one of the weight subsets; encoding a weight subset flag into a particular portion of a bitstream, wherein the weight subset flag contains a weight subset index used to identify the one of the weight subsets that was selected; and transmitting the bitstream containing the weight subset flag to a decoding device.

Optionally, in any of the preceding aspects, another implementation of the aspect provides that the one of the weight subsets selected contains only a single weight.

Optionally, in any of the preceding aspects, another implementation of the aspect provides that the step of dividing the available weights for the current inter block into the weight subsets comprises dividing the available weights into larger weight subsets initially and then dividing the large weight subsets to form the weight subsets.

Optionally, in any of the preceding aspects, another implementation of the aspect provides for selecting a single weight from the one of the weight subsets that was selected.

Optionally, in any of the preceding aspects, another implementation of the aspect provides that the particular portion is one or more of a sequence parameter set (SPS) level of the bitstream and a picture parameter set (PPS) level of the bitstream, a slice header of the bitstream, and a region of the bitstream represented by a coding tree unit (CTU) or group of CTUs.

Optionally, in any of the preceding aspects, another implementation of the aspect provides for encoding the weight subset flag using variable length coding so that a number of bins in the weight subset flag is one less than a number of weights in the weight subset index.

Optionally, in any of the preceding aspects, another implementation of the aspect provides for encoding the weight subset flag using fixed length coding so that a number of bins in the weight subset flag is at least two less than a number of weights in the weight subset index.

According to one aspect of the present disclosure, there is provided a coding apparatus. The coding apparatus includes a receiver configured to receive a bitstream containing a weight subset flag in a particular portion; a memory coupled to the receiver, the memory containing instructions; a processor coupled to the memory, the processor configured to execute the instructions stored in the memory to cause the processor to: parse the bitstream to obtain the weight subset flag in the particular portion; and identify a weight subset using the weight subset flag, wherein the weight subset comprises a subset of available weights for a current inter block; and a display coupled to the processor, the display configured to display an image generated based on the weight subset.

Optionally, in any of the preceding aspects, another implementation of the aspect provides that the particular portion is a sequence parameter set (SPS) level of the bitstream.

Optionally, in any of the preceding aspects, another implementation of the aspect provides that the particular portion is a picture parameter set (PPS) level of the bitstream.

Optionally, in any of the preceding aspects, another implementation of the aspect provides that the particular portion is a slice header of the bitstream.

Optionally, in any of the preceding aspects, another implementation of the aspect provides that the particular portion is a region of the bitstream represented by a coding tree unit (CTU) or group of CTUs.

Optionally, in any of the preceding aspects, another implementation of the aspect provides that the available weights comprise all weights used in generalized bi-prediction (GBi).

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram illustrating an example coding system that may utilize bidirectional prediction techniques.

FIG. 2 is a block diagram illustrating an example video encoder that may implement bidirectional prediction techniques.

FIG. 3 is a block diagram illustrating an example of a video decoder that may implement bidirectional prediction techniques.

FIG. 4 is a diagram of a current block and spatial generalized bidirectional (GBi) neighbors.

FIG. 5 is a schematic diagram of a network device.

FIG. 6 is a flowchart illustrating an embodiment of a coding method.

FIG. 7 is a flowchart illustrating an embodiment of a coding method.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

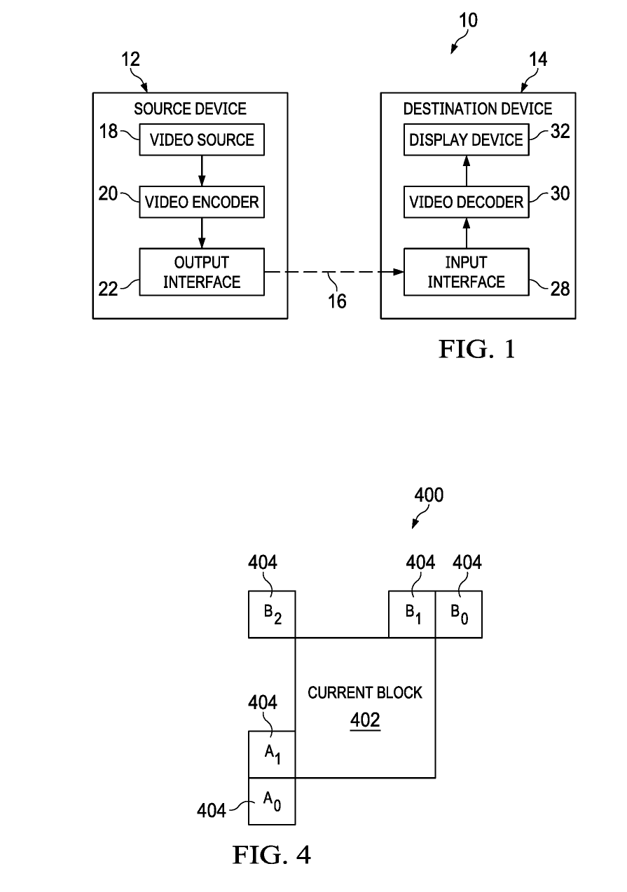

FIG. 1 is a block diagram illustrating an example coding system 10 that may utilize bidirectional prediction techniques. As shown in FIG. 1, the coding system 10 includes a source device 12 that provides encoded video data to be decoded at a later time by a destination device 14. In particular, the source device 12 may provide the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, digital video disks (DVD)s, Compact Disc Read-Only Memories (CD-ROMs), flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), a file transfer protocol (FTP) server, network attached storage (NAS) devices, or a local disk drive. Destination device 14 may access the encoded video data through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, coding system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 and/or the video decoder 30 of the destination device 14 may be configured to apply the techniques for bidirectional prediction. In other examples, a source device and a destination device may include other components or arrangements. For example, source device 12 may receive video data from an external video source, such as an external camera. Likewise, destination device 14 may interface with an external display device, rather than including an integrated display device.

The illustrated coding system 10 of FIG. 1 is merely one example. Techniques for bidirectional prediction may be performed by any digital video encoding and/or decoding device. Although the techniques of this disclosure generally are performed by a video coding device, the techniques may also be performed by a video encoder/decoder, typically referred to as a “CODEC.” Moreover, the techniques of this disclosure may also be performed by a video preprocessor. The video encoder and/or the decoder may be a graphics processing unit (GPU) or a similar device.

Source device 12 and destination device 14 are merely examples of such coding devices in which source device 12 generates coded video data for transmission to destination device 14. In some examples, source device 12 and destination device 14 may operate in a substantially symmetrical manner such that each of the source and destination devices 12, 14 includes video encoding and decoding components. Hence, coding system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video.

In some cases, when video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., group of pictures (GOPs). Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 may operate according to a video coding standard, such as the High Efficiency Video Coding (HEVC) standard presently under development, and may conform to the HEVC Test Model (HM). Alternatively, video encoder 20 and video decoder 30 may operate according to other proprietary or industry standards, such as the International Telecommunications Union Telecommunication Standardization Sector (ITU-T) H.264 standard, alternatively referred to as Motion Picture Expert Group (MPEG)-4, Part 10, Advanced Video Coding (AVC), H.265/High Efficiency Video Coding (HEVC), or extensions of such standards. The techniques of this disclosure, however, are not limited to any particular coding standard. Other examples of video coding standards include MPEG-2 and ITU-T H.263. Although not shown in FIG. 1, in some aspects, video encoder 20 and video decoder 30 may each be integrated with an audio encoder and decoder, and may include appropriate multiplexer-demultiplexer (MUX-DEMUX) units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device. A device including video encoder 20 and/or video decoder 30 may comprise an integrated circuit, a microprocessor, and/or a wireless communication device, such as a cellular telephone.

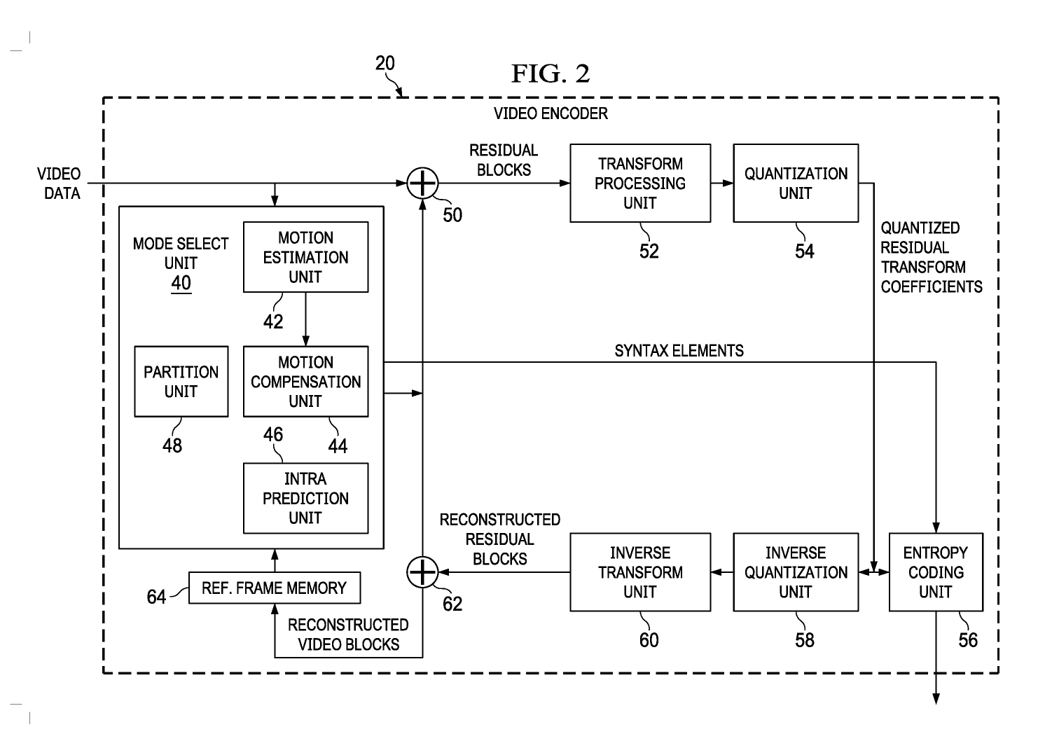

FIG. 2 is a block diagram illustrating an example of video encoder 20 that may implement bidirectional prediction techniques. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes mode select unit 40, reference frame memory 64, summer 50, transform processing unit 52, quantization unit 54, and entropy coding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into largest coding units (LCUs), and partition each of the LCUs into sub-coding units (sub-CUs) based on rate-distortion analysis (e.g., rate-distortion optimization). Mode select unit 40 may further produce a quadtree data structure indicative of partitioning of a LCU into sub-CUs. Leaf-node CUs of the quadtree may include one or more prediction units (PUs) and one or more transform units (TUs).

The present disclosure uses the term “block” to refer to any of a CU, PU, or TU, in the context of HEVC, or similar data structures in the context of other standards (e.g., macroblocks and sub-blocks thereof in H.264/AVC). A CU includes a coding node, PUs, and TUs associated with the coding node. A size of the CU corresponds to a size of the coding node and is square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy coding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

In addition, intra-prediction unit 46 may be configured to code depth blocks of a depth map using a depth modeling mode (DMM). Mode select unit 40 may determine whether an available DMM mode produces better coding results than an intra-prediction mode and the other DMM modes, e.g., using rate-distortion optimization (RDO). Data for a texture image corresponding to a depth map may be stored in reference frame memory 64. Motion estimation unit 42 and motion compensation unit 44 may also be configured to inter-predict depth blocks of a depth map.

After selecting an intra-prediction mode for a block (e.g., a conventional intra-prediction mode or one of the DMM modes), intra-prediction unit 46 may provide information indicative of the selected intra-prediction mode for the block to entropy coding unit 56. Entropy coding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation.

Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used.

Transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy coding unit 56 entropy codes the quantized transform coefficients. For example, entropy coding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy coding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

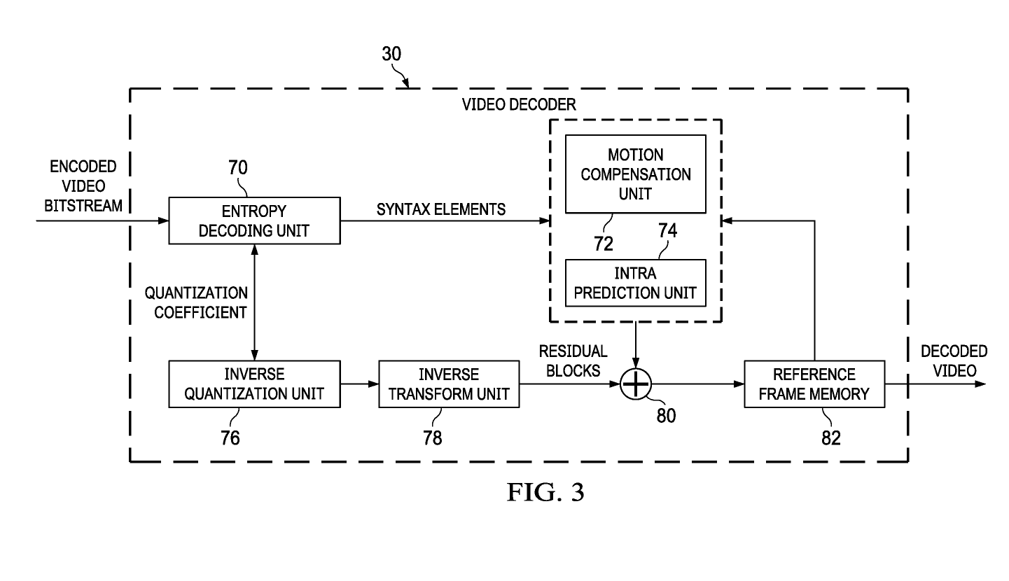

FIG. 3 is a block diagram illustrating an example of video decoder 30 that may implement bidirectional prediction techniques. In the example of FIG. 3, video decoder 30 includes an entropy decoding unit 70, motion compensation unit 72, intra-prediction unit 74, inverse quantization unit 76, inverse transformation unit 78, reference frame memory 82, and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference frame memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Data for a texture image corresponding to a depth map may be stored in reference frame memory 82. Motion compensation unit 72 may also be configured to inter-predict depth blocks of a depth map.

As will be appreciated by those in the art, the coding system 10 of FIG. 1 is suitable for GBi. GBi is an inter-prediction technique that generates a prediction signal of a block by computing a weighted average of two motion-compensated prediction blocks using block-level adaptive weights. Unlike conventional bi-prediction, the values of the weights in GBi (which may be referred to as GBi weights) are not restricted to 0.5. The inter-prediction technique for GBi may be formulated as follows:

P[x]=(1−w)*P₀[x+v₀]+w*P₁[x+v₁], (1)

where P[x] denotes the prediction of a current-block sample located at a picture position x, each Pᵢ[x+vᵢ], ∀i∈{0, 1} is the motion-compensated prediction of the current-block sample associated with a motion vector (MV) vᵢ from a reference picture in reference list Li, and w and 1−w represent weight values applied to P₀[x+v₀] and P₁[x+v₁], respectively.

In GBi, there are three different sets of candidate weights, which include:
W₁={⅜, ½, ⅝},
W₂=W₁ ∪{¼, ¾}={¼, ⅜, ½, ⅝, ¾},
W₃=W₂ ∪{−¼, 5/4}={−¼, ¼, ⅜, ½, ⅝, ¾, 5/4}.

During coding, a block is divided into partitions by an encoder such as video encoder 20. For example, a 64×64 block may be divided into 32×32 blocks. These smaller blocks may be referred to as leaf nodes in a quadtree plus binary tree (QTBT) structure. To indicate where w is located in the set (e.g., W1, W2, or W3) of candidate weights, an index is introduced at the leaf node of the QTBT structure to indicate the entry position where w is located in the set (that is W1, W2, or W3) of candidate weights. Thereafter, index binarization takes place using one of the two binarization schemes specified in Table 1. As shown, each sequence level test (e.g., Test 1, Test 2, etc.) contains index numbers (e.g., 0, 1, 2, 3, etc.) corresponding to a weight value (e.g., ⅜) and a binarization codeword (e.g., 00, 1, 02, 0001, etc.) formed from bins (e.g., a 0 or a 1) for each scheme.

TABLE 1

| | | Binarization Schemes | |
|---|---|---|---|
| | Weight | Scheme #1 | Scheme #2 |
| Index | value | (mvd_l1_zero_flag = 0) | (mvd_l1_zero_flag = 1) |

Test 1: W₁

| | | | |
|---|---|---|---|
| 0 | ⅜ | 00 | 00 |
| 1 | ½ | 1 | 01 |
| 2 | ⅝ | 01 | 1 |

Test 2: W₂

| | | | |
|---|---|---|---|
| 0 | ¼ | 0000 | 0000 |
| 1 | ⅜ | 001 | 0001 |
| 2 | ½ | 1 | 01 |
| 3 | ⅝ | 01 | 1 |
| 4 | ¾ | 0001 | 001 |

Test 3: W₃

| | | | |
|---|---|---|---|
| 0 | −¼ | 000000 | 000000 |
| 1 | ¼ | 00001 | 000001 |
| 2 | ⅜ | 001 | 0001 |
| 3 | ½ | 1 | 01 |
| 4 | ⅝ | 01 | 1 |
| 5 | ¾ | 0001 | 001 |
| 6 | 5/4 | 000001 | 00001 |

The choice of the binarization scheme is adapted for each slice, depending on the value of the slice-level flag, mvd_11_zero_flag, which indicates whether a motion vector difference (MVD) for the second reference picture list is equal to zero and therefore not signaled in the bitstream. When the slice-level flag is equal to 0, Scheme #1 is used. When the slice-level flag is equal to 1, Scheme #2 is used. Each bin (e.g., 0 or 1) in the binarization codeword is then context-coded after binarization.

This index of w (e.g., ⅜, ½, etc.) is signaled explicitly when a bi-prediction block uses signaling MVD. Otherwise, no additional overhead from the syntax is introduced. Then, the following rules are applied for determining the weight value for each PU. For each bi-prediction block in a QTBT leaf node that uses signaling MVD (i.e. normal inter-prediction mode and affine prediction mode), its weight value is set equal to the explicitly signaled w. For each bi-prediction block in a QTBT leaf node that is coded with merge modes, advanced temporal motion vector prediction or the affine merge mode, its weight value w is inferred directly from the weight value used for the associated merge candidate. For the remaining bi-prediction blocks, their weight values are set equal to 0.5.

In existing solutions, there are seven different weights to choose from for each coded block. All seven weights are explicitly signaled by various length coding methods using up to six bins. For example, under Test 3 in Table 1, seven weights (e.g., −¼, ¼, ⅜, ½, ⅝, ¾, 5/4) are provided, which calls for codewords comprising six bins (e.g., 000000, 000001). In some cases, the more weights that are used in the video coding process, the better the image quality produced. However, using a greater number of weights mandates the use of larger codewords, which increases coding complexity.

Disclosed herein are methods to enable, perform, and signal adaptive weighted bidirectional inter-prediction at various levels using less than all of the seven different weights. For example, the inventors observed that video (or image) content in a localized region or area may have some continuity. Therefore, not all seven weights may need to be coded. Rather, localized or region and block-based adaptive weights can be used to reduce coding complexity and improve coding performance. This present disclosure presents a set of methods to do so.

In an embodiment, a subset of all available weights are selected and signaled at different levels of a bitstream, e.g., sequence parameter set (SPS), picture parameter set (PPS), slice header or a region represented by a coding tree unit (CTU) or group of CTUs. As used herein, the SPS may be referred to as the sequence level, the PPS may be referred to as the parameter level, the slice header may be referred to as the slice level, and so on. In addition, the subset of available weights may be referred to interchangeably as a weight subset or a GBi weight subset.

In an embodiment, the selected weights in the slice header may be a subset of the weights in SPS or PPS. In an embodiment, the selected weights of a local region (e.g., CTU or group of CTUs) may be a subset of the weights in slice header or SPS or PPS. The weight for the current coded block is then selected from the subset of its parent level, which may be a CTU, group of CTUs, slice header, PPS, or SPS.

An example of the signaling using three weight subsets and variable length coding is provided for the purpose of illustration. In such a case, the weight subset flag uses two bins to code three weight subset indexes. Here, M represents the number of weight indexes. As such, M=3. M−1 bins are used to signal the selected block weight index. Therefore, the codewords used in the binarization scheme are 0, 10, 11.

| Weight subset index | Weight subset value |
|---|---|
| 0 | {⅜, ½, ⅝} |
| 1 | {¼, ⅜, ½, ⅝, ¾} |
| 2 | {−¼, ¼, ⅜, ½, ⅝, ¾, 5/4} |

Another example of the signaling using four weight subsets and fixed length coding is provided for the purpose of illustration. In such a case, the weight subset flag uses two bins to code four weight subset indexes. Again, M represents the number of weight indexes. However, unlike the variable length coding example, log 2(M) bins are used to signal the selected blow weight index. As such, M=4. Therefore, the codewords used in the binarization scheme are 00, 10, 01, 11.

| Weight subset index | Weight subset value |
|---|---|
| 0 | {⅜, ½, ⅝} |
| 1 | {¼, ⅜, ½, ⅝, ¾} |
| 2 | {−¼, ¼, ⅜, ½, ⅝, ¾, 5/4} |
| 3 | {−⅜, −¼, ¼, ⅜, ½, ⅝, ¾, 5/4, 11/8} |

In an embodiment, the weight subset index can be indicated in the sequence level (e.g., SPS) with a flag using, for example, the following syntax:

General sequence parameter set RBSP syntax

| seq_parameter_set_rbsp( ) { | Descriptor |
|---|---|
| .... | |
| sps_gbi_weight_subset_index | ae(v) |
| ... | |
| } | |

where sps_gbi_weight_subset_index specifies the index of the GBi weight subset that is applied to the reconstructed pictures in the current sequence.

In an embodiment, the weight subset index can be indicated in the picture level (e.g., PPS) with a flag using, for example, the following syntax:

Picture parameter set range extension syntax

| pps_range_extension( ) { | Descriptor |
|---|---|
| .... | |
| pps_gbi_weight_subset_index | ae(v) |
| ... | |
| } | |

where pps_gbi_weight_subset_index specifies the index of the GBi weight subset that is applied to the reconstructed blocks in the current picture.

In an embodiment, the use of the weight subset is signaled independently in either the SPS level or the PPS level, but not in both the SPS and the PPS levels. For example, when sps_gbi_weight_subset_index is available, then pps_gbi_weight_subset_index is not present, and vice versa.

In an embodiment, the use of the weight subset is signaled in both the SPS and the PPS level. In such cases, the PPS signal takes precedence and overwrites the SPS signal when they both exist.

In an embodiment, the weight subset index can be indicated in the slice level: The weight subset index can be indicated in slice level with a flag using, for example, the following syntax:

| slice_segment_header( ) { | Descriptor |
|---|---|
| ... | |
| slice_gbi_weight_subset_index | ae(v) |
| ... | |
| } | |

where slice_gbi_weight_subset_index specifies the index of the GBi weight subset that is applied to the reconstructed blocks in the current slice.

In an embodiment, the GBi weights for the current slice (e.g., signaled in the slice header) are all of the GBi weights allowed or a subset of the allowed (or signaled) GBi weights for the current picture (signaled in PPS, or SPS if the GBi signaling in PPS does not exist).

In an embodiment, the weight subset index can be indicated in the CTU level. The weight subset index can be indicated in the CTU level with a flag using, for example, the following syntax:

| coding_tree_unit( ) { | Descriptor |
|---|---|
| ... | |
| CTU_gbi_weight_subset_index | ae(v) |
| ... | |
| } | |

where CTU_gbi_weight_subset_index specifies the index of the GBi weight subset that is applied to the reconstructed blocks in the current CTU.

In one embodiment, the GBi weights for the current CTU are all of the GBi weights allowed or a subset of the allowed (or signaled) GBi weights for the current slice (e.g., signaled in slice header), or the whole or a subset of the allowed GBi weights for the current picture (e.g., signaled in PPS, or SPS if the GBi signaling in PPS does not exist).

In an embodiment, the number of weights in the subset is one. In such an embodiment, there is no need to signal the weights for each coded block. Indeed, the weights used for each coded block are inferred to be the one signaled in its upper level syntax. Also, the selection of the subset of weights (e.g., the 3 or 4 weights out of total 7 weights) may be dependent on the weights used in the previous picture or slice or region. That is, the selection is made based on temporal information.

Disclosed herein is also a method of using a single weight selected from all of the available GBi weights. That is, only one weight out of all available GBi weights is selected at each different level by using a flag. For example, when seven GBi weights are available, the value for each weight index and its corresponding weight value are as shown in Table 2. In an embodiment, the weight index is coded by using variable length coding or fixed length coding.

TABLE 2

| weight | weight | variable length | fixed length |
|---|---|---|---|
| index | value | coding | coding |
| 0 | ½ | 0 | 000 |
| 1 | ⅝ | 1 | 001 |
| 2 | ⅜ | 01 | 010 |
| 3 | ¾ | 001 | 011 |
| 4 | ¼ | 0001 | 100 |
| 5 | 5/4 | 00001 | 101 |
| 6 | −¼ | 000001 | 110 |

In an embodiment, the weight index can be indicated in the sequence level with a flag using, for example, the following syntax:

General Sequence Parameter Set RBSP Syntax

| seq_parameter_set_rbsp( ) { | Descriptor |
|---|---|
| .... | |
| sps_gbi_weight_index | ae(v) |
| ... | |
| } | |

where sps_gbi_weight_index specifies the index of the GBi weight that is applied to the reconstructed pictures in the current sequence.

In an embodiment, the weight index can be indicated in the picture level with a flag using, for example, the following syntax:

Picture Parameter Set Range Extension Syntax

| pps_range_extension( ) { | Descriptor |
|---|---|
| .... | |
| pps_gbi_weight_index | ae(v) |
| ... | |
| } | |

where pps_gbi_weight_index specifies the index of the GBi weight that is applied to the reconstructed blocks in the current picture.

In an embodiment, the usage of the weight subset is signaled independently in either the SPS level or the PPS level, but not in both the SPS and the PPS levels. For example, sps_gbi_weight_index is available, then pps_gbi_weight_index is not present, and vice versa.

In an embodiment, the use of the weight subset is signaled in both the SPS and the PPS level. In such cases, the PPS signal takes precedence and overwrites the SPS signal when they both exist.

In an embodiment, the weight subset index can be indicated in the slice level: The weight subset index can be indicated in slice level with a flag using, for example, the following syntax:

| slice_segment_header( ) { | Descriptor |
|---|---|
| ... | |
| slice_gbi_weight_index | ae(v) |
| ... | |
| } | |

where slice_gbi_weight_index specifies the index of the GBi weight that is applied to the reconstructed blocks in the current slice.

In one embodiment, the GBi weight allowed for the current slice (e.g., signaled in the slice header) is only one of the allowed (or signaled) GBi weights for current picture (signaled in the PPS, or the SPS if the GBi signaling in the PPS does not exist).

In an embodiment, the weight subset index can be indicated in the CTU level. The weight subset index can be indicated in the CTU level with a flag using, for example, the following syntax:

| coding_tree_unit( ) { | Descriptor |
|---|---|
| ... | |
| CTU_gbi_weight_index | ae(v) |
| ... | |
| } | |

where CTU_gbi_weight_index specifies the index of the GBi weight that is applied to the reconstructed blocks in the current CTU.

In one embodiment, the GBi weight allowed for the current CTU is only one of the allowed (or signaled) GBi weights for current slice (signaled in slice header), or one of the allowed GBi weights for the current picture (signaled in the PPS, or the SPS if the GBi signaling in the PPS does not exist).

When a specific GBi weight is selected at picture (SPS, PPS), slice (slice header) or region (CTU header) level, all inter coded blocks within this picture, slice, or region use this GBi weight. There is no need to signal the GBi weight in each block.

Disclosed herein is also a method of using a single weight selected from a weight subset of all of the available GBi weights. That is, only one weight from a weight subset of all available GBi weights is selected at each different level by using a flag.

For example, we divide seven GBi weights into three weight subsets. Each subset contains at least one of the available GBi weights.

| Weight subset index | Weight subset value |
|---|---|
| 0 | {⅜, ½, ⅝} |
| 1 | {¼, ⅜, ½, ⅝, ¾} |
| 2 | {−¼, ¼, ⅜, ½, ⅝, ¾, 5/4} |

For the first subset, the relationship between weight index and weight value can be shown in below table.

| weight | weight |
|---|---|
| index | value |
| 0 | ½ |
| 1 | ⅝ |
| 2 | ⅜ |

For the second subset, the relationship between weight index and weight value can be shown in below table.

| weight | weight |
|---|---|
| index | value |
| 0 | ½ |
| 1 | ⅝ |
| 2 | ⅜ |
| 3 | ¾ |
| 4 | ¼ |

For the third subset, the relationship between weight index and weight value can be shown in below table.

| weight | weight |
|---|---|
| index | value |
| 0 | ½ |
| 1 | ⅝ |
| 2 | ⅜ |
| 3 | ¾ |
| 4 | ¼ |
| 5 | 5/4 |
| 6 | −¼ |

In this embodiment, the GBi weight subset index and GBi weight index can be shown in the same level, or shown in different levels, as described below.

In an embodiment, the weight subset index and the weight index can be indicated in sequence level with a flag using, for example, the following syntax:

General Sequence Parameter Set RBSP Syntax

| seq_parameter_set_rbsp( ) { | Descriptor |
|---|---|
| .... | |
| sps_gbi_weight_subset_index | ae(v) |
| sps_gbi_weight_index | ae(v) |
| ... | |
| } | |

where sps_gbi_weight_subset_index specifies the index of the GBi weight subset that is applied to the reconstructed pictures in the current sequence, and where sps_gbi_weight_index specifies the index of the GBi weight that is applied to the reconstructed pictures in the current sequence.

Each sequence, picture, slice or region represented by CTU or group of CTUs can use the same method.

In an embodiment, the weight index can be indicated in picture level with a flag using, for example, the following syntax:

Picture Parameter Set Range Extension Syntax

| pps_range_extension( ) { | Descriptor |
|---|---|
| .... | |
| pps_gbi_weight_subset_index | ae(v) |
| pps_gbi_weight_index | ae(v) |
| ... | |
| } | |

where pps_gbi_weight_subset_index specifies the index of the GBi weight subset that is applied to the reconstructed blocks in the current picture, and where pps_gbi_weight_index specifies the index of the GBi weight that is applied to the reconstructed blocks in the current picture.

In an embodiment, the weight index can be indicated in slice level with a flag using, for example, the following syntax:

| slice_segment_header( ) { | Descriptor |
|---|---|
| ... | |
| slice_gbi_weight_subset_index | ae(v) |
| slice_gbi_weight_index | ae(v) |
| ... | |
| } | |

where slice_gbi_weight_subset_index specifies the index of the GBi weight subset that is applied to the reconstructed blocks in the current slice, and where slice_gbi_weight_index specifies the index of the GBi weight that is applied to the reconstructed blocks in the current slice.

In an embodiment, the weight subset index and weight index can be signaled in different levels. For example, a certain subset of weights used for a slice can be signaled in a picture header. Thereafter, a slice header signals the weight index corresponding to a weight that was selected from the subset of weights in the picture header. One example syntax table is shown below. This may be expanded to other variants.

General Sequence Parameter Set RBSP Syntax

| seq_parameter_set_rbsp( ) { | Descriptor |
|---|---|
| .... | |
| sps_gbi_weight_subset_index | ae(v) |
| ... | |
| } | |

Picture Parameter Set Range Extension Syntax

| pps_range_extension( ) { | Descriptor |
|---|---|
| .... | |
| pps_gbi_weight_subset_index | ae(v) |
| ... | |
| } | |

| slice_segment_header( ) { | Descriptor |
|---|---|
| ... | |
| slice_gbi_weight_index | ae(v) |
| ... | |
| } | |

where sps_gbi_weight_subset_index specifies the index of the GBi weight subset that is applied to the reconstructed pictures in the current sequence, where pps_gbi_weight_subset_index specifies the index of the GBi weight subset that is applied to the reconstructed blocks in the current picture, and where slice_gbi_weight_index specifies the index of the GBi weight that is applied to the reconstructed blocks in the current slice.

In an embodiment, the weight subset of a current region can be adaptively indicated depending on the neighbor(s) using a flag signaled at different levels. The current and neighboring region can be a group of CTUs, a CTU, a CU, a PU, etc. For example, in the CTU level, the selected weight subset can be derived from neighboring CTU using the following syntax:

| coding_tree_unit( ) { | Descriptor |
|---|---|
| ... | |
| ctu_gbi_merge_flag | u(1) |
| ... | |
| } | |

where ctu_gbi_merge_flag equal to 1 specifies that the GBi weight subset for the current coding tree unit is derived from the corresponding syntax elements of the neighboring coding tree block, and where ctu_gbi_merge_flag equal to 0 specifies that these syntax elements are not derived from the corresponding syntax elements of the neighboring coding tree block.

Disclosed herein is also a method of using a weight of a neighbor as the weight for the current block. FIG. 4 is a diagram 400 of a current block 402 and spatial GBi neighbors 404. In an embodiment, the spatial GBi neighbors 404 comprise a bottom-left spatial neighbor A0, a left spatial neighbor A1, a top-right spatial neighbor B0, a top spatial neighbor B1, and a top-left spatial neighbor B2. Other spatial GBi neighbors 404, at different positions relative to the current block 402, may be used or considered in different embodiments.

In an embodiment, the weight for current block 402 may be the same as the weight used for any one of its neighbors. The neighbors may be spatial GBi neighbors 404, e.g. top, left, top-left, top-right and bottom-left, etc., or temporal neighbors. In an embodiment, the temporal neighbor block is found in one of the previously coded pictures, which is identified using a temporal motion vector predictor (TMVP). A pruning process may be performed to prune out identical weights from the different neighbors. The remaining different weights, denoted M, then form a list. Their indices are signaled and sent from the encoder to the decoder.

In an embodiment, the weight for current block 402 may be the same as its top or left neighbor (e.g., top spatial neighbor B1 and a top-left spatial neighbor B2). In such cases, a flag is used to signal the top or left selection. The flag may be, for example, one bin or one bit. When the weights used in two or more neighbors are the same, then there is no need to code or send the flag. In an embodiment, the flag may be context coded using, for example, CABAC. CABAC is a form of entropy encoding used in the H.264/MPEG-4 AVC and HEVC standards. CABAC is a lossless compression technique, although the video coding standards in which it is used are typically for lossy compression applications.

In an embodiment, the weights of the spacial GBi neighbors 404 form a GBi weight candidate list (e.g. GBiWeightCandList) using, for example, the following syntax.
i=0
if(availableFlagA₁)
   GBiWeightCandList [i++]=A₁
if(availableFlagB₁)
   GBiWeightCandList [i++]=B₁
if(availableFlagB₀)
   GBiWeightCandList [i++]=B₀
if(availableFlagA₀)
   GBiWeightCandList [i++]=A₀
if(availableFlagB₂)
   GBiWeightCandList [i++]=B₂

The GBi weight of the current block (e.g., block 402) may be equal to one of the GBi weights in the GBiWeightSubsetCandList. One example syntax table is shown below. First, a flag (e.g., cu_gbi_merge_flag) is signaled to indicate whether the GBi weight of the current block is merged to be equal to one of its neighbors. If yes (indicated by the flag cu_gbi_merge_flag), then the index of the used GBi weight for the current block (e.g., gbi_merge_idx) is signaled. This index may be coded by variable length coding with context(s). If the first flag (e.g., cu_gbi_merge_flag) indicates that the GBi weight of the current block is not the same as any GBi weight in the GBi weight candidate list (e.g., GBiWeightCandList), then in one embodiment the GBi weight index of the current block is explicitly signaled using one of the methods or embodiments described herein. In an embodiment, the GBi weight of the current block is inferred to be equal to a specific value, e.g. ½. In another embodiment, the current block does not use GBi for prediction.

| coding_unit( ) { | Descriptor |
|---|---|
| ... | |
| cu_gbi_merge_flag | u(1) |
| if( cu_gbi_merge_flag ) | |
| gbi_merge_idx | av(e) |
| ... | |
| } | |

where cu_gbi_merge_flag equal to 1 specifies that the GBi weight of the current coding unit is equal to one of the weights in the weight candidate list, where ctu_gbi_merge_flag equal to 0 specifies that the GBi weight of the current coding unit is not equal to one of the weights in the weight candidate list, and where gbi_merge_idx specifies which weight in the candidate list is used for the current coding unit.

In an embodiment, the coding unit may be replaced by a prediction unit or a block in general.

Disclosed herein is also a method of using most probable and remaining weights for the current block. In such a method, the possible weights for the current coded block are categorized into two types, e.g., most probable weights (MPW) and remaining weights (RMW). A flag is used to signal whether the weight for the current block is one of the most probable weights. The flag may be one bit or one bin, and may be context coded.

In an embodiment, the most probable weights are the weights used by neighbors, e.g., top and left neighbors. In an embodiment, the most probable weights are the weights that are used with a high probability. For example, the weight ½ or ⅝ may have a high probability of being used relative to the other available weights.

When the weight is one of the most probable weights, a second flag is used to identify the most probable weight being used. In one embodiment, the codewords 0, 01, 11 are signaled for the first three available and valid (different) weights among {top, left, ½, ⅝, ⅜} or {left, top, ½, ⅝, ⅜). The order and values may vary. In an embodiment, the bins 0, 1 may be signaled for the first two available and valid (different) weights among {top, left, ½, ⅝} or {left, top, ½, ⅝} or left, top, ½, ⅜). The order and values may vary.

When the first flag indicates that the weight for the current block is not an MPW (i.e., the weight is one of the remaining weights), then a second flag is used to indicate which remaining weight it is. The remaining weights may be coded by fixed length coding or variable length coding. In addition, the first flag to indicate MPW or RMW may be context coded. The second flag to indicate the weight index may be context coded or partially context coded. In one example, the first bin of the remaining weight index is context coded while the other bins that follow are bypass coded.

Using, for example, seven GBi weights in the most probable weights context, a sample relationship between weight index and a corresponding weight value is shown in table below.

| weight index | weight value |
|---|---|
| 0 | ½ |
| 1 | ⅝ |
| 2 | ⅜ |
| 3 | ¾ |
| 4 | ¼ |
| 5 | 5/4 |
| 6 | −¼ |

The on/off control for the most probable weights can be indicated at different levels using a flag. For example, the CU level flag may be used as shown by the syntax below.

| coding_unit( x0, y0, log2CbSize ) { | |
|---|---|
| ... | |
| prev_gbi_weight_flag[ x0 + i ][ y0 + j ] | u(1) |
| if(prev_gbi_weight_flag[ x0 + i ][ y0 + j ] ) | |
| mpm_weight_idx [ x0 + i ][ y0 + j ] | ae(v) |
| else | |
| rem_pred_weight [ x0 + i ][ y0 + j ] | ae(v) |

The array indices x0+i, y0+j specify the location (x0+i, y0+j) of the top-left luma sample of the considered prediction block relative to the top-left luma sample of the picture. The syntax element prev_gbi_weight_flag[x0+i][y0+j] being equal to 1 specifies that the value of mpm_weight_idx is applied to the reconstructed picture in the current CU. prev_gbi_weight_flag[x0+i][y0+j] being equal to 0 specifies that the value of rem_pred_weight is applied to the reconstructed picture in the current CU.

mpm_weight_idx[x0+i][y0+j] specifies the index of the most probable weights. In addition, rem_{—} pred_weight [x0+i][y0+j] specifies the remaining GBi weight that is different from most probable weight.

In an example where there are seven GBi weights, when the set of most probable weights includes three weights, then the remaining GBi weights are the other 4 weights. In this example, two bin fixed length coding can be used to code the remaining weights.

In an embodiment, the predicted weight of GBi is derived from neighbors using the following ordered steps. First, the neighboring locations (xNbA, yNbA) and (xNbB, yNbB) are set equal to (xPb−1, yPb) and (xPb, yPb−1), respectively.

Second, for X being replaced by either A or B, the variables candIntraPredModeX are derived as follows.
The availability derivation process for a block in z-scan order, which is specified in clause 6.4.1 of “High Efficiency Video Coding,” ITU-T Recommendation|International Organization for Standardization (ISO)/International Electrotechnical Commission (IEC) 23008-2, December, 2016, which is incorporated herein by reference, is invoked with the location (xCurr, yCurr) set equal to (xPb, yPb) and the neighboring location (xNbY, yNbY) set equal to (xNbX, yNbX) as inputs, and the output is assigned to availableX.

The candidate weight candweightX is derived as follows:

If availableX is equal to FALSE, candweightX is set equal to 0.5.

Otherwise, candIntraPredModeX is set equal to WeightPred [xNbX][yNbX].

The candWeightList[x] is derived as follows, x can be 0 to he number of the weight. In this embodiment, x is equal to 0 to 2, for example.

If candWeightB is equal to candWeightA, the following applies:
If candWeightA is equal to ½ or ⅝, candModeList[x] with x=0 . . . 2 is derived as follows:
   candWeightList[0]=½
   candWeightList[1]=⅝
   candWeightList[2]=¾
Otherwise, candModeList[x] with x=0 . . . 2 is derived as follows:
   candWeightList[0]=candWeightA
   candWeightList[1]=½
   candWeightList[2]=⅝
Otherwise (candWeightB is not equal to candWeightA), the following applies:
   candWeightList[0] and candWeightList[1] are derived as follows:
   candWeightList[0]=candWeightA
   candWeightList[1]=candWeightB
If neither of candWeightList[0] and candWeightList[1] is equal to ½, candWeightList[2] is set equal to ½,
Otherwise, if neither of and WeightList[0] and candWeightList[1] is equal to ⅝, candWeightList[2] is set equal to ⅝,
Otherwise, candModeList[2] is set equal to ¾.

Third, the weight of the current block is derived by applying the following procedure:
If prev_gbi_weight_flag[x0+i][y0+j] is equal to 1, The weight of current block is set equal to candModeList[mpm_weight_idx].
Otherwise, The weight of current block WeightPred [xPb][yPb] is derived by applying the following ordered steps:
   WeightPred [xPb][yPb] is set equal to rem_{—} pred_weight [xPb][yPb].
   For i equal to 0 to 2, inclusive, when WeightPred [xPb][yPb] is greater than or equal to candModeList[i], the value of WeightPred [xPb][yPb] is incremented by one.

In an embodiment, for i equal to 0 to 2, inclusive, when WeightPred [xPb][yPb] is greater than or equal to candModeList[i], the value of WeightPred [xPb][yPb] is reduced by one.

In an embodiment, besides the above neighboring region and left neighboring region, a third neighbor region (e.g., top-left neighbors) may also be used. In an embodiment, the x could be 0 to 1. When x is set to be 0 to 1, then the candWeightList[2] does not exist. In such a case, only candWeightList[0] and candWeightList[1] need to be derived and the rest of the method can be performed as described above.

In an embodiment, the x could be 0 to 3. When x is set to be 0 to 3, besides the above neighboring region and the left neighboring region, a third neighboring region (e.g., top-left neighbors) or the most used weight (for example, ½) can be used as an candidates.

In another embodiment, the remaining weight can also be the weights, denoted as N, that are non most probable weights. Here, N is smaller than the result of total number of the GBi weights minus most probable weights. Examples are provided below to illustrate.

For GBi weights with the order of {½, ⅜, ⅝, ¼, ¾, −¼, 5/4}, when the most probable weights are ½, ⅝, ⅜, and N=3, then the remaining weights are the first three weights of non most probable weights, e.g., {¼, ¾, −¼}. For GBi weights with the order of {½, ⅝, ⅜, ¼, ¾, 5/4, −¼}, when the most probable weights are ½, ⅝, ⅜, and N=3, then the remaining weights are the first three weights of non most probable weights, e.g., {¼, ¾, 5/4}.

Disclosed herein is also a method of using an inter merge mode. For example, when the current block is inter coded using the inter merge mode, the weight for the current block is inferred to be equal to the weight used for the inter coded block indicated by the inter merge index or pointed to by the motion vector indicated by the my merge index.

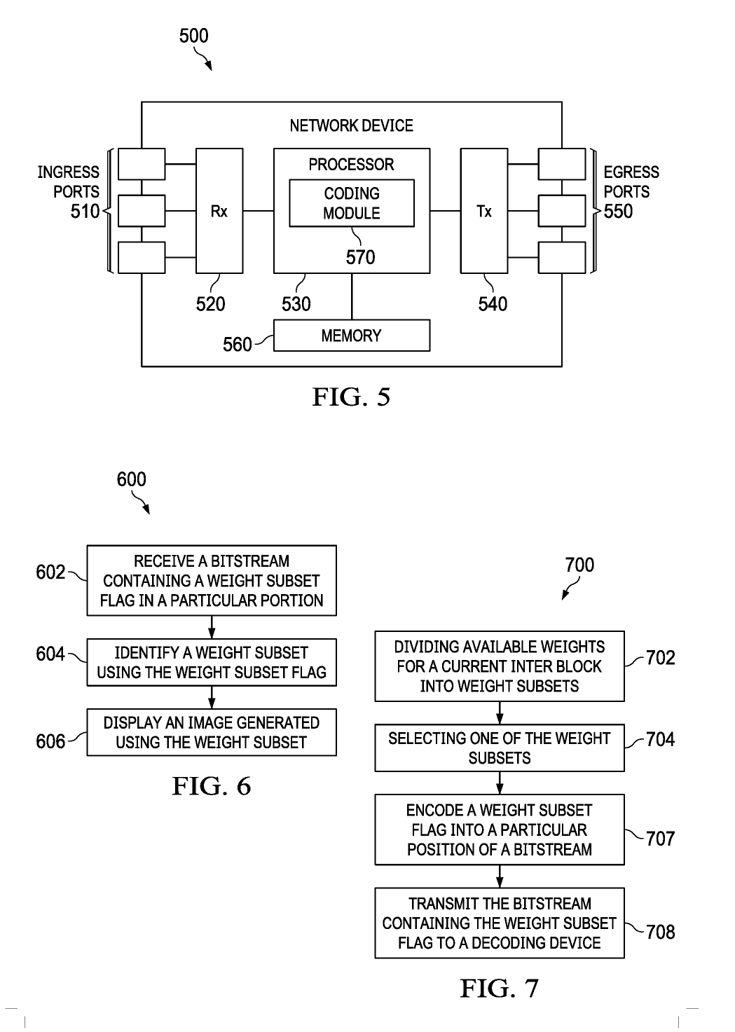

FIG. 5 is a schematic diagram of a network device 500 (e.g., a coding device) according to an embodiment of the disclosure. The network device 500 is suitable for implementing the disclosed embodiments as described herein. In an embodiment, the network device 500 may be a decoder such as video decoder 30 of FIG. 1 or an encoder such as video encoder 20 of FIG. 1. In an embodiment, the network device 500 may be one or more components of the video decoder 30 of FIG. 1 or the video encoder 20 of FIG. 1 as described above.

The network device 500 comprises ingress ports 510 and receiver units (Rx) 520 for receiving data; a processor, logic unit, or central processing unit (CPU) 530 to process the data; transmitter units (Tx) 540 and egress ports 550 for transmitting the data; and a memory 560 for storing the data. The network device 500 may also comprise optical-to-electrical (OE) components and electrical-to-optical (EO) components coupled to the ingress ports 510, the receiver units 520, the transmitter units 540, and the egress ports 550 for egress or ingress of optical or electrical signals.

The processor 530 is implemented by hardware and software. The processor 530 may be implemented as one or more CPU chips, cores (e.g., as a multi-core processor), FPGAs, ASICs, and DSPs. The processor 530 is in communication with the ingress ports 510, receiver units 520, transmitter units 540, egress ports 550, and memory 560. The processor 530 comprises a coding module 570. The coding module 570 implements the disclosed embodiments described above. For instance, the coding module 570 implements, processes, prepares, or provides the various coding operations. The inclusion of the coding module 570 therefore provides a substantial improvement to the functionality of the network device 500 and effects a transformation of the network device 500 to a different state. Alternatively, the coding module 570 is implemented as instructions stored in the memory 560 and executed by the processor 530.

The memory 560 comprises one or more disks, tape drives, and solid-state drives and may be used as an over-flow data storage device, to store programs when such programs are selected for execution, and to store instructions and data that are read during program execution. The memory 560 may be volatile and/or non-volatile and may be read-only memory (ROM), random access memory (RAM), ternary content-addressable memory (TCAM), and/or static random-access memory (SRAM).

FIG. 6 is a flowchart illustrating an embodiment of a coding method 600. In an embodiment, the coding method 600 is implemented in a decoder such as the video decoder 30 in FIG. 1. The coding method 600 may be implemented when, for example, a bitstream received from an encoder, such as the video encoder 20 of FIG. 1, is to be decoded in order to generate an image on the display of an electronic device.

In block 602, a bitstream containing a weight subset flag in a particular portion is received. The particular portion may be, for example, the SPS of the bitstream, the PPS of the bitstream, the slice header of the bitstream, or a region of the bitstream represented by a CTU or group of CTUs.

In block 604, a weight subset is identified using the weight subset flag. In an embodiment, the weight subset comprises a subset of available weights for a current inter block. In an embodiment, the available weights for the current block include at least −¼, ¼, ⅜, ½, ⅝, ¾, and 5/4. In an embodiment, the available weights may include at least one weight in addition to the set of −¼, ¼, ⅜, ½, ⅝, ¾, and 5/4.

In block 606, an image is displayed on a display of an electronic device. The image is generated using the weight subset that was identified by the weight subset flag. The image may be a picture or a frame from a video.

FIG. 7 is a flowchart illustrating an embodiment of a coding method 700. In an embodiment, the coding method 700 is implemented in an encoder such as video encoder 20 in FIG. 1. The coding method 700 may be implemented when, for example, a bitstream is to be generated and transmitted to a decoding device such as the video decoder 30 in FIG. 1.

In block 702, the available weights for a current inter block are divided into weight subsets. For example, the available weights are the set of −¼, ¼, ⅜, ½, ⅝, ¾, and 5/4, and the subsets are {¼, ¾, −¼}, {¼, ¾, 5/4}, and {¼, ⅜, ½, ⅝}. It should be appreciated that any number of subsets containing various combinations of weights may be used in practical applications.

In block 704, one of the weight subsets is selected for encoding. For example, the subset of {¼, ¾, −¼} may be selected. In block 706, a weight subset flag is encoded into a particular portion of a bitstream. The weight subset flag contains a weight subset index used to identify the one of the weight subsets that was selected. The particular portion may be, for example, the SPS of the bitstream, the PPS of the bitstream, the slice header of the bitstream, or a region of the bitstream represented by a CTU or group of CTUs.

In block 708, the bitstream containing the weight subset flag is transmitted to a decoding device such as the video decoder 30 in FIG. 1. When the bitstream is received by the decoding device, the decoding device may implement the process of FIG. 6 to decode the bitstream.

Based on the foregoing, those skilled in the art will recognize that existing solutions allow seven different weights to code the current inter block. The weight index of all seven weights is explicitly signaled by various length coding method using up to six bins. In contrast, the present disclosure presents a set of methods to reduce the number of weights and thus the signaling bits in an adaptive manner based on the observation that video (or image) content in a localized region or area typically has some continuities. Methods are also presented to infer the weights for the current inter block by utilizing neighbor block information, or to code the weights using the proposed most probable weights concept and scheme.

A method of coding implemented by a decoder. The method includes receiving, by means for receiving, a bitstream containing a weight subset flag in a particular portion; identifying, by means for identifying, a weight subset using the weight subset flag, wherein the weight subset comprises a subset of available weights for a current inter block; and displaying on a display of an electronic device, by means for displaying, an image generated using the weight subset that was identified by the weight subset flag.

A method of coding implemented by an encoder. The method includes dividing, by means for dividing, available weights for a current inter block into weight subsets; selecting one of the weight subsets; encoding, by means for encoding, a weight subset flag into a particular portion of a bitstream, wherein the weight subset flag contains a weight subset index used to identify the one of the weight subsets that was selected; and transmitting, by means for transmitting, the bitstream containing the weight subset flag to a decoding device.

A coding apparatus. The coding apparatus includes receiver means configured to receive a bitstream containing a weight subset flag in a particular portion; memory means coupled to the receiver means, the memory means containing instructions; processor means coupled to the memory means, the processor means configured to execute the instructions stored in the memory means to cause the processor means to: parse the bitstream to obtain the weight subset flag in the particular portion; and identify a weight subset using the weight subset flag, wherein the weight subset comprises a subset of available weights for a current inter block; and display means coupled to the processor means, the display means configured to display an image generated based on the weight subset.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of coding implemented by a decoder, comprising:
receiving a bitstream containing a weight subset flag in a particular portion;
identifying a weight subset using the weight subset flag, wherein the weight subset comprises a subset of available weights for a current inter block; and
displaying, on a display of an electronic device, an image generated using the weight subset that was identified by the weight subset flag.

2. The method of claim 1, wherein the available weights correspond to generalized bi-prediction (GBi).

3. The method of claim 1, wherein the particular portion is a sequence parameter set (SPS) level of the bitstream.

4. The method of claim 1, wherein the particular portion is a picture parameter set (PPS) level of the bitstream.

5. The method of claim 1, wherein the particular portion is a slice header of the bitstream.

6. The method of claim 1, wherein the particular portion is a region of the bitstream represented by a coding tree unit (CTU) or group of CTUs.

7. The method of claim 1, wherein the available weights for the current block include at least one weight in addition to −¼, ¼, ⅜, ½, ⅝, ¾, and 5/4.

8. A method of coding implemented by an encoder, comprising:
dividing available weights for a current inter block into weight subsets;
selecting one of the weight subsets;
encoding a weight subset flag into a particular portion of a bitstream, wherein the weight subset flag contains a weight subset index used to identify the one of the weight subsets that was selected; and
transmitting the bitstream containing the weight subset flag to a decoding device.

9. The method of claim 8, wherein the one of the weight subsets selected contains only a single weight.

10. The method of claim 8, wherein the step of dividing the available weights for the current inter block into the weight subsets comprises dividing the available weights into larger weight subsets initially and then dividing the large weight subsets to form the weight subsets.

11. The method of claim 10, further comprising selecting a single weight from the one of the weight subsets that was selected.

12. The method of claim 8, wherein the particular portion is one or more of a sequence parameter set (SPS) level of the bitstream and a picture parameter set (PPS) level of the bitstream, a slice header of the bitstream, and a region of the bitstream represented by a coding tree unit (CTU) or group of CTUs.

13. The method of claim 8, further comprising encoding the weight subset flag using variable length coding so that a number of bins in the weight subset flag is one less than a number of weights in the weight subset index.

14. The method of claim 8, further comprising encoding the weight subset flag using fixed length coding so that a number of bins in the weight subset flag is at least two less than a number of weights in the weight subset index.

15. A coding apparatus, comprising:
a receiver configured to receive a bitstream containing a weight subset flag in a particular portion;
a memory coupled to the receiver, the memory containing instructions;
a processor coupled to the memory, the processor configured to execute the instructions stored in the memory to cause the processor to:
parse the bitstream to obtain the weight subset flag in the particular portion; and
identify a weight subset using the weight subset flag, wherein the weight subset comprises a subset of available weights for a current inter block; and
a display coupled to the processor, the display configured to display an image generated based on the weight subset.

16. The coding apparatus of claim 15, wherein the particular portion is a sequence parameter set (SPS) level of the bitstream.

17. The coding apparatus of claim 15, wherein the particular portion is a picture parameter set (PPS) level of the bitstream.

18. The coding apparatus of claim 15, wherein the particular portion is a slice header of the bitstream.

19. The coding apparatus of claim 15, wherein the particular portion is a region of the bitstream represented by a coding tree unit (CTU) or group of CTUs.

20. The coding apparatus of claim 15, wherein the available weights comprise all weights used in generalized bi-prediction (GBi).
